(19) United States
(12) Patent Application Publication
(10) Pub. No.: US 2018/0325151 A1
(43) Pub. Date: Nov. 15, 2018

(54) METHOD OF PRODUCING INSTANT GINSENG CHICKEN SOUP PRODUCT

(71) Applicant: HARIM CORPORATION, Iksan-si (KR)

(72) Inventor: Bo Suk KIM, Jeonju-si (KR)

(73) Assignee: HARIM CORPORATION, Iksan-si (KR)

(21) Appl. No.: 15/961,927

(22) Filed: Apr. 25, 2018

(30) Foreign Application Priority Data
May 10, 2017 (KR) 10-2017-0057969

(51) Int. Cl. A23L 23/10; A23L 29/00; A23L 5/10

(52) U.S. Cl. CPC A23L 23/10; A23L 29/035; A23L 5/13; A23V 2002/00; A23V 2300/20; A23V 2250/2124; A23V 2300/14; A23V 2300/24; A23V 2200/15

(57) ABSTRACT

Disclosed is a method of producing instant ginseng chicken soup product, the method including cooking chicken meat, which is filled with stuffing, for ginseng chicken soup with 100% steam using a steam cooker, extracting broth from chicken feet using a heat exchange heater, diluting 65 parts by weight of purified water and 5 parts by weight of food additive in 30 parts by weight of the extracted broth and then adding a seasoning agent thereto to obtain a broth seasoning liquid, and packing the prepared chicken meat and the broth seasoning liquid in a package and performing a retort heat treatment and rapid freezing at a temperature less than or equal to −35° C.

### CROSS-REFERENCE TO RELATED APPLICATION

This application claims priority to and the benefit of Korean Patent Application No. 10-2017-0057969, filed on May 10, 2017, the disclosure of which is incorporated herein by reference in its entirety.

### BACKGROUND

### 1. Field of the Invention

The present disclosure relates to a method of producing an instant ginseng chicken soup product, and more particularly, to a method of producing an instant ginseng chicken soup product in which chicken meat with glutinous rice, fresh ginseng, and jujube put therein is cooked with 100% steam and heat-treated, a food additive is used to eliminate an off-flavor and disgusting odor unique to chicken that may be produced in instant ginseng chicken soup product, moisture is replenished to inside and outside tissues of the chicken meat to maintain elasticity of meat, and, when extracting broth, a heat exchange heater is used to adjust pressure and temperature so that homogenous broth is extracted in a short time.

### 2. Discussion of Related Art

ginseng chicken soup has long been known as a healthy dish for people who are weak. Specifically, ginseng chicken soup is good for a person who has cold body and is highly sensitive to cold, frequently gets dry, sweats heavily in a normal body condition, gets tired easily, eats only what he or she likes, or has low concentration. Particularly, ginseng chicken soup is a traditional food proved to be effective in the recovery of energy of a person who is weak or has a poor appetite, a pregnant woman before or after she gives birth to a child, and a patient who is ill in bed. Due to being effective in supplementing energy which is easy to consume in the season of summer, consumption of ginseng chicken soup is concentrated in the season of summer.

Chicken meat, which is the main ingredient of ginseng chicken soup, is a high-protein food that has a clean taste and is easily digested and absorbed because fibers that make up the meat are thin, long, and soft, and the fat is not mixed in the muscles. Pregnant women who need to intake fat and quality protein have long been eating seaweed soup boiled with chicken meat. Chicken meat has numerous essential amino acids including methionine, and thus eating chicken meat is an effective method for promoting the growth of granulation tissues. Particularly, the protein in chicken meat contains many linoleic acids among fatty acids, thus being effective in preventing adult diseases and being suitable for diets of the elderly or patients, and also contains high levels of vitamin A, vitamin B1, vitamin B2, and niacin. In addition, the presence of many mucins in chicken wing portions promotes growth, improves exercise function, and enhances absorption of protein.

Because it takes a significant amount of time and effort to cook ginseng chicken soup which has the above-described advantageous effects, there is an inconvenience in enjoying eating ginseng chicken soup in a modern way of life. Thus, efforts have been made to develop a method of producing instant-cooking ginseng chicken soup which can be easily and conveniently consumed in a short time without a complicated cooking process, and ginseng chicken soup processed food has been developed as a convenience food.

Although the above-mentioned method of producing instant-cooking ginseng chicken soup has an advantage of allowing ginseng chicken soup to be easily and conveniently cooked and consumed, there are problems in that texture of food is significantly deteriorated due to an odor and flavor unique to chicken meat, and it is difficult to extract homogenous broth when producing broth.

### RELATED ART DOCUMENT

(Patent Document 1) [Patent Document 1] Korean Patent Registration No. 10-1217651 (Dec. 26, 2012)

(Patent Document 2) [Patent Document 2] Korean Patent Registration No. 10-1264985 (May 9, 2013)

### SUMMARY OF THE INVENTION

The present disclosure has been devised in consideration of the conventional problems, and it is an aspect of the present disclosure to provide a method of producing instant ginseng chicken soup in which chicken meat with glutinous rice, fresh ginseng, and jujube put therein is cooked with 100% steam and heat-treated, a food additive is used to eliminate an off-flavor and disgusting odor unique to chicken that may be produced in instant ginseng chicken soup product, and moisture is replenished to inside and outside tissues of the chicken meat to maintain elasticity of meat.

It is another aspect of the present disclosure to provide a method of producing instant ginseng chicken soup in which, when extracting broth using chicken feet, a heat exchange heater is used to adjust pressure and temperature and perform a heat exchange so that homogenous broth may be extracted in a short time.

To achieve the above aspects, the present disclosure provides a method of producing instant ginseng chicken soup product, the method including cooking chicken meat, which is filled with stuffing, for ginseng chicken soup with 100% steam using a steam cooker, extracting broth from chicken feet using a heat exchange heater, diluting 30 parts by weight of the extracted broth and 5 parts by weight of the food additive with 65 parts by weight of purified water and then adding a seasoning agent thereto to obtain a broth seasoning liquid, and packing the prepared chicken meat and the broth seasoning liquid in a package and performing a retort heat treatment and rapid freezing at a temperature less than or equal to −35° C.

The steam cooker may be provided in a process including a first step process in which the chicken meat filled with stuffing is placed on a tray and then put in a cooker using a carriage, a second step process in which, after the first step process, 100% steam is inserted into the inside of the cooker so that a surface of the chicken meat is prevented from being dried out, and a third step process in which cooling water is sprayed at the chicken meat which is steam-cooked through the second step process so that, simultaneously, fat and foreign substances on the surface of the chicken meat are removed and temperature of the surface of the chicken meat is maintained to be less than or equal to 40° C.

In the second step process, the steam-cooking may be performed for 40 to 55 minutes at a temperature ranging from 85 to 90° C.

The broth extracted through the heat exchange heater may be provided in a process including a first step process in which chicken feet are put in hot water at a temperature of 85 to 99° C., the chicken feet are dipped therein for 10 to 15 seconds, and then skin of the chicken feet is removed using a drum depilator, a second step process in which the skinned chicken feet are heated for 10 to 20 minutes while temperature of an extractor is 60° C. to blanch the chicken feet, a third step process in which blood is removed from the chicken feet, which have gone through the second step process, using a hose twice for 15 to 20 minutes at a temperature of 60° C., and a fourth step process in which the chicken feet, from which blood has been removed, is put in a heat exchange type heater-extractor along with purified water and vegetables so that, when the temperature reaches 105° C., the chicken feet, the purified water, and the vegetables are heated for 210 minutes±30 minutes, and an undiluted solution of broth is extracted.

In the fourth step process, a pressure of heating in the heat exchange type heater-extractor may be adjusted as 1.1 pa, and the pressure may be removed every one hour for broth to be extracted while a heat exchange is performed.

A mixture ratio of raw materials extracted with the broth may be 100 parts by weight that includes 8 to 12 parts by weight of chicken feet, 1 to 3 parts by weight of onion, 0.5 to 1.5 parts by weight of garlic, 0.2 to 0.4 parts by weight of ginger, and purified water filling the remaining parts by weight.

For the broth extracted by the heat exchange type heater-extractor, 30 parts by weight of the broth, 65 parts by weight of purified water, and 5 parts by weight of the food additive may be diluted in a dilution tank and then boiled for 5 minutes at a temperature ranging from 90 to 100° C.

The broth seasoning agent boiled in the dilution tank may be put in the mixture, boiled for five more minutes, and then dissolved in the mixture to obtain a broth seasoning liquid.

When measured using a salinometer, the broth seasoning liquid may have a salinity based on 0.75 to 0.06 parts by weight at measurement temperature in the range of 37±2° C.

The overall mixture ratio of raw materials of the instant ginseng chicken soup put in the package may be 100 parts by weight that includes 40 to 45 parts by weight of chicken meat, 4 to 6 parts by weight of glutinous rice, 0.5 to 1.5 parts by weight of fresh ginseng, 0.3 to 0.5 parts by weight of jujube, and the broth seasoning liquid filling the remaining parts by weight.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a process chart of a method of producing an instant ginseng chicken soup product according to the present disclosure; and

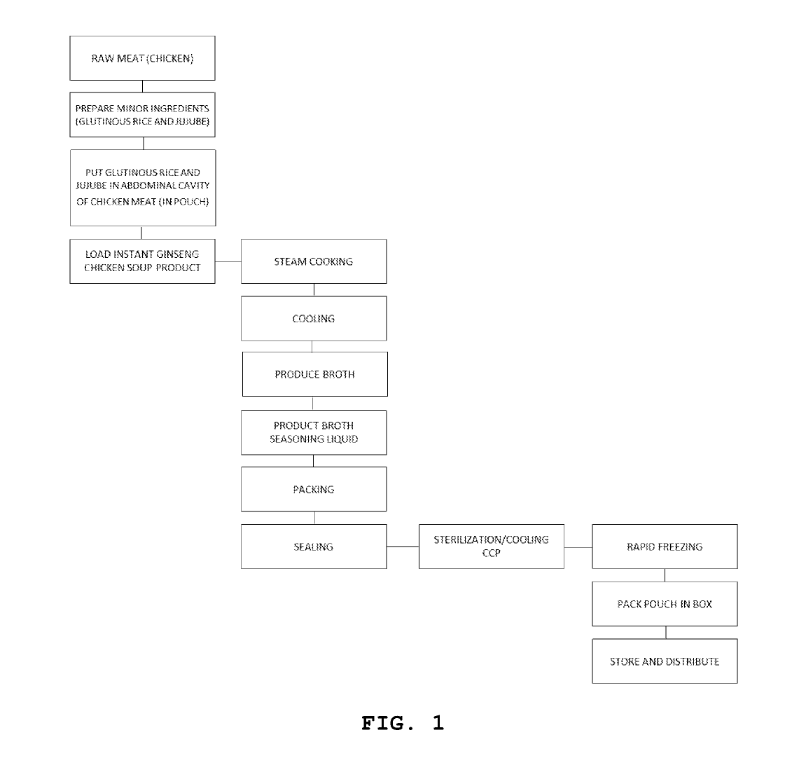

FIG. 2 is a graph showing core temperatures of chicken meat of the instant ginseng chicken soup product per five minutes when the chicken meat is steam-cooked according to the present disclosure.

### DETAILED DESCRIPTION OF EXEMPLARY EMBODIMENTS

Hereinafter, the present disclosure will be described in more detail with reference to exemplary embodiments thereof.

A method of producing an instant ginseng chicken soup product of the present disclosure includes cooking chicken meat, which is filled with stuffing, for ginseng chicken soup with 100% steam using a steam cooker, extracting broth from chicken feet using a heat exchange heater, diluting 65 parts by weight of purified water and 5 parts by weight of a food additive in 30 parts by weight of the extracted broth and then adding a seasoning agent thereto to obtain a broth seasoning liquid, and packing the prepared chicken meat and the broth seasoning liquid in a package and performing a retort heat treatment and rapid freezing at a temperature less than or equal to −35° C.

In order to carry out the present disclosure, chicken meat, glutinous rice and jujube filled in the chicken meat, chicken feet, onion, garlic, ginger, purified water for obtaining broth, and sun-dried sea salt, white pepper, white sugar, and purified water which correspond to a seasoning agent are used as basic ingredients.

The instant ginseng chicken soup according to the present disclosure is completely produced through a process of obtaining chicken meat that is steam-cooked through a steam cooker, broth that is extracted from chicken feet using a heat exchange heater, and a broth seasoning liquid that is obtained by adding the food additive and a seasoning agent to the broth, packing the obtained chicken meat, broth, and broth seasoning liquid in a package, and rapidly freezing the package.

This will be described in detail with reference to examples.

### Example 1

Process of Steam-Cooking Chicken Meat Using Steam Cooker

First, chicken meat corresponding to a base material, which is a main ingredient, was prepared. In this case, fresh chicken meat was used. Healthy chicken, instead of ill or weak chicken, was purchased, and the purchased chicken was slaughtered so that hair, feet, neck, uropygial gland, and an inedible portion in an abdominal cavity of the chicken were removed. Raw chicken meat in the weight range of 350 g to 500 g was used as the chicken meat.

Also, lung, heart, fat, etc. remaining in the abdominal cavity, remaining hair, and yellow skin on epidermis of the chicken were removed, and the uropygial gland and neck of the chicken were cut off. Externally, the slaughtered chicken had to have no bruises and no fractured parts. When the above conditions were adhered to, in order to optimize quality of instant ginseng chicken soup product, inedible portions attached to the inside and outside of the chicken meat were thoroughly removed, and the chicken meat was washed.

The glutinous rice put in the chicken meat was prepared by being thoroughly washed, soaked in water for 1 to 2 hours, and then dehydrated, and about 3 to 5 g each of jujube was washed and prepared.

When preparation of chicken meat, glutinous rice, and jujube was completed as described above, the abdominal cavity of the chicken meat was filled with jujube and 45 g of washed glutinous rice. Then, to prevent the glutinous rice and jujube from coming out of the chicken meat, a cut was made in skin of a lower part of one leg of the chicken, and the other leg was fit into the cut so that the legs form an X-shape.

The chicken meat filled with glutinous rice and jujube was passed through a metal detector, and when no abnormality was detected, a steam-cooking process was performed on the chicken meat.

The chicken meat filled with glutinous rice and jujube was placed on a cooking tray, put in a steam cooker using a carriage, and then cooked and heat-treated. In this case, equipment capable of cooking using 100% steam was used as the steam cooker used in steam-cooking.

The steam-cooking by the steam cooker was performed for 40 to 55 minutes at a temperature ranging from 85 to 90° C., and 100% steam was inserted into the steam cooker to prevent the surface of the chicken meat from being dried out. Then, cooling water was sprayed at the cooked chicken meat so that fat and foreign substances at the surface of the chicken meat were removed. In this case, the temperature of the surface of the chicken meat was maintained to be less than or equal to 40° C.

Steam cooking has advantageous effects of being able to remove fat and foreign substances, destroying microorganisms, and improving yield and texture of meat. Also, steam cooking has advantageous effects of producing a desirable texture, improving flavor, and lengthening shelf life.

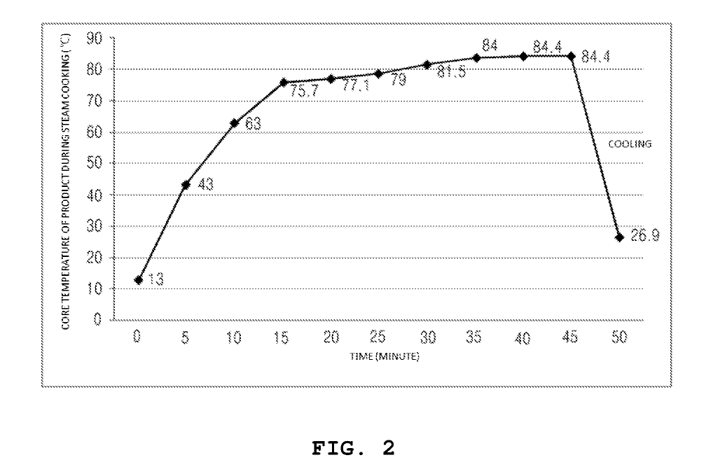

When the chicken meat was inserted into the steam cooker and steam cooked, the core temperature of the chicken meat every five minutes was changed such that, as shown in FIG. 2, the core temperature of the chicken meat reached 84.4° C. when the steam-cooking had been performed for 40 to 55 minutes.

Process of Extracting Broth from Chicken Feet Using Heat Exchange Heater

A predetermined amount of prepared chicken feet was inserted into hot water at a temperature ranging from 85 to 99° C., the chicken feet were dipped therein for 10 to 15 seconds, and then skin of the chicken feet was removed using a drum depilator, or the skin of the chicken feet was sufficiently removed and washed in a jacketed kettle and used.

Then, since when temperature and time are exceeded, skin of chicken feet is cooked together with chicken meat such that the skin of the chicken feet is not separated from the chicken meat, it was necessary to observe the temperature and time. Also, since when a large amount of chicken feet is dipped at once and left outside the water for a long period of time, the skin of the chicken feet is not separated from the chicken meat, it was preferable to dip a small amount of chicken feet at a time and remove the skin of the chicken feet.

Blanching Chicken Feet

Chicken feet from which skin was removed were used, and chicken feet that were refrigerated after parts at which foreign substances, claws, spots, etc. were present were cleanly removed were used.

Washing Chicken Feet

In washing blanched chicken feet, the blanched chicken feet were washed using a hose about twice for 15 to 20 minutes at a temperature of 60° C. so that no blood comes out of the blanched chicken feet (whether blood had been completely removed was determined by checking drainage pipes).

Producing Broth

The washed chicken feet were inserted into a heat exchange type heater-extractor along with purified water and vegetables, and when the temperature reached 105° C., the chicken feet, the purified water, and the vegetables were heated for 210 minutes±30 minutes, and an undiluted solution of broth was extracted. From among the inserted vegetables, onion was divided into four pieces, ginger was sliced into 10 mm-sized pieces as much as possible, and garlic was inserted as whole.

In this case, a pressure of the heat exchange type heater-extractor was adjusted to 1.1 pa, and the pressure was removed every one hour (concept of stirring).

An optimum ratio and a most optimum ratio of the broth extracted from the heat exchange type heater-extractor as described above are shown in Table 1 below.

TABLE 1

| | Optimum ratio | Most optimum ratio |
|---|---|---|
| Ingredient name | (parts by weight) | (parts by weight) |
| Chicken feet | 8 to 12 | 10 |
| Onion | 1 to 3 | 2 |
| Garlic | 0.5 to 1.5 | 1 |
| Ginger | 0.2 to 0.4 | 0.3 |
| Purified water | 76.7 to 96.7 | 86.7 |
| Total | | 100 |

Transfer and Storage of Broth

After broth was extracted, steam was discharged from the extracted broth for about 15 minutes, and the broth was transferred to a cooling tank and cooled to 65±5° C. so that fat at the epidermis layer may be completely removed. (cooling was performed until 65° C. was reached, and a cooling valve was locked upon reaching 65° C.). The broth cooled in the cooling tank was transferred to a cold storage and stored therein.

Process of Producing Broth Seasoning Liquid

After the broth was extracted, 30 parts by weight of the broth, 65 parts by weight of purified water, and 5 parts by weight of the food additive were diluted in a dilution tank, the broth and the purified water were boiled in the dilution tank for 5 minutes at a temperature ranging from 90 to 98° C., a seasoning agent was inserted into the mixture, boiled for five more minutes, and then dissolved in the mixture to produce a broth seasoning liquid.

Ingredients used for the above-mentioned seasoning agent include sun-dried sea salt, white sugar, white pepper, purified water etc., and the seasoning agent was a commonly-used seasoning agent. When the seasoning agent was inserted, the salinity of the seasoning agent was measured using a salinometer, and the broth seasoning liquid may have a salinity based on 0.75 to 0.06 parts by weight at measurement temperature in the range of 37±2° C.

In this case, rhubarb powder, a wormwood vinegar, a wood vinegar, and a rhodinic acid (F) were selectively used as the food additive.

The scientific name of the rhubarb used as the food additive is Rheum rhaponticum L. Rhubarb is referred to as Jangunpul in South Korea and Daehwang in China. The place of origin of rhubarb is known to be southern Siberia. Rhubarb has been cultivated since ancient Greek and Roman times and has been used for medicinal and edible purposes. Rhubarb is cultivated at altitudes of 2,000 to 4,000 m above sea level in northern Europe, China, Tibet, North America, and the like. In Korea, rhubarb is mainly produced in areas around Gwanmobong of Baekdu Mountain. There are various types of rhubarb including Rheum palmatum L., Rheum coreanim Nakai, and Rheum tonguticum Max., and rhubarb is classified into various types such as Rheum palmatum, Rheum coreanum, Rheum tanguticum, Rheum officinale, and Rumex aquaticus L. Rhubarb contains Sennoside A-F, which is dianthrone glycoside, and chrysophe-nol, emodin, aloe-emodin, rhein, physcoin, citreorosein, chrysophanol-1- and -8-glucoside, emodin-1- and -8-glucoside etc. as anthraquion derivatives.

The rhubarb powder is in powder form obtained by pulverizing rhubarb leaf stalks. When used in meat, the rhubarb powder is considered to have an antioxidant effect.

The wormwood vinegar used as the food additive includes various types of wormwood. In the oriental medicine field, the wormwood vinegar is known as alkaline-rich food that is rich in vitamin B2, vitamin C and minerals such as iron, calcium, potassium, and phosphorus, and is good for the improvement of acidified physical constitutions of modern people. Also, since the wormwood vinegar contains a large amount of chlorophyll which has an anti-cancer effect, one can prevent cancer by steadily consuming the wormwood vinegar. Particularly, the wormwood vinegar is one of the best seasonal foods that prevent and treat skin dryness, respiratory diseases, and allergic symptoms.

According to “Folk Remedy,” wormwood is effective for a wide variety of diseases such as hepatitis, hypertension, stroke, migraine, abdominal pain, heat rashes, eczema, neuralgia, bruises, tonsillitis, backache, and hemorrhoids. In “Donguibogam (Principles and Practice of Eastern Medicine),” it is written that wormwood has a property of being warm and strengthens functions of the stomach, liver, and kidney, thus being effective in treating abdominal pain. The effect of clearing blood and the actions such as sterilization, analgesia, and inflammation are also confirmed by science as effects of wormwood.

When the wormwood vinegar is used as the food additive, not only the functionality of instant ginseng chicken soup is improved but also the odor of the food is improved, the meat is softened, and the taste is improved.

The wood vinegar used as the food additive is made by collecting smoke generated when carbonizing oak wood and rapidly cooling the collected smoke whereafter the generated wood vinegar is fixed or distilled for 6 to 12 months. 80 to 90% of wood vinegar is water, and the remainder is 200 or more types of organic compounds, and the wood vinegar has a unique smoke smell.

Recently, the wood vinegar has been discovered to be highly effective for maintaining health of the human body. Some of the effects are known to be detoxification (fatigue recovery) of the liver, anti-stress effect due to a decrease of epinephrine level in the blood, alleviation of menopausal disorder symptoms, prevention of hair loss, and maintenance of blood glucose balance.

When used in meat, the wood vinegar not only improves the taste but may also exhibit various effects by being consumed in the human body.

The rhodinic acid used as the food additive is one among substances extracted from the natural world, and is one among components which is a natural substance and used to inhibit the growth of food additives, microorganisms, or the like. The molecular weight of the rhodinic acid is 170.25, and the linear molecular formula is (CH₃)₂C═CHCH₂CH₂CH(CH₃)CH₂CO₂H. When the rhodinic acid is used, the growth of microorganisms may be inhibited.

The rhubarb powder, the wormwood vinegar, the wood vinegar, and the (F)rhodinic acid, which are food additives used as described above, may be used such that 30 parts by weight of broth, 65 parts by weight of purified water, and 5 parts by weight of the rhubarb powder are diluted, 30 parts by weight of broth, 65 parts by weight of purified water, and 5 parts by weight of the wormwood vinegar are diluted, or 30 parts by weight of broth, 65 parts by weight of purified water, and 5 parts by weight of the (F)rhodinic acid are diluted, but it should be noted that, according to circumstances, the rhubarb powder, the wormwood vinegar, the wood vinegar, and the (F)rhodinic acid may be diluted in the ratio of 5:2:2:1 and then used as the food additive.

Packing (in Pouch) and Sealing

After the cooled and dehydrated chicken meat and fresh ginseng (one piece) were inserted into a pouch, the broth seasoning liquid, which had been prepared by dilution, was injected into the pouch until the ankle of the chicken meat was dipped in the broth seasoning liquid. In this case, temperature of the broth seasoning liquid is preferably as high as possible, greater than or equal to 80° C., and the pouch was sealed by maximally removing air therefrom upon inserting the broth seasoning liquid into the pouch. This is preferable since the vacuum may be maintained to some extent, and the internal oxygen residual amount may be kept to a minimum.

The optimum ratio and the most optimum ratio of the chicken meat, glutinous rice, fresh ginseng, jujube, and broth seasoning liquid filled in the pouch as described above are shown in Table 2 below.

TABLE 2

| | Optimum ratio | The most optimum ratio |
|---|---|---|
| Ingredient name | (parts by weight) | (parts by weight) |
| Chicken meat | 40 to 45 | 42 |
| Glutinous rice | 4 to 6 | 5 |
| Fresh ginseng | 1.5 to 1.7 | 1.6 |
| Jujube | 0.3 to 0.5 | 0.4 |
| Broth seasoning liquid | 41 to 61 | 51 |
| Total | | 100 |

Sterilization and Cooling

Sterilization

The sealed instant ginseng chicken soup was sterilized for 35±1 minutes at temperature in the range of 100±2° C., and is cooled for 30±1 minutes. In this case, the pressure was 1.30±2 bar, and the sealed instant ginseng chicken soup was immediately sterilized without being left outside for a long period of time.

Cooling

Since the product temperature was still high, there was a risk of degrading the sealed instant ginseng chicken soup by introduction of thermophilic bacteria. Thus, the sealed instant ginseng chicken soup was cooled so that the product temperature was 40° C. or lower.

Rapid Freezing

The sealed instant ginseng chicken soup was rapidly frozen by passing the sealed instant ginseng chicken soup through a rapid freezing machine at a temperature less than or equal to −35° C. The rapid freezing method was an air blast freezing method in which rapid freezing is performed with cold air at a temperature ranging from 30 to 40° C. in a tunnel shape. The purpose of rapid freezing was to inhibit proliferation of microorganisms and minimize chemical or enzymatic changes and changes in characteristics such as color, odor, taste, and juiciness so that the initial chewy texture of chicken meat is maintained.

The case in which the core temperature passes through the maximum ice crystal generation time zone within 30 minutes is referred to as rapid freezing. The rapid freezing machine herein may rapidly cool the sealed instant ginseng chicken soup so that the core temperature thereof passes through the maximum ice crystal generation time zone within 30 minutes and changes in cell tissues thereof are maintained to be minimal.

The sealed ginseng chicken soup that is rapidly frozen as described above is packed in a pouch box, stored, distributed, and sold.

### Example 2

The measured antioxidant effect of the rhubarb powder, which is the food additive, according to the present disclosure is shown in Table 3 below.

TABLE 3

| | | | Instant |
|---|---|---|---|
| | Instant ginseng | Instant ginseng | ginseng chicken |
| | chicken soup in | chicken soup in | soup of the present |
| Type | market 1 | market 2 | disclosure |
| DPPH | 46.88 | 50.33 | 65.12 |
| (% Inhibition) | | | |
| Total | 172.88 | 193.34 | 319.22 |
| polyphenol | | | |
| (μg/g) | | | |

(Given values are averages of 3 times)

In Table 3, for the 2,2-diphenyl-1-picryl-hydrazyl-hydrate (DPPH) radical scavenging activity, a DPPH solution having a concentration of 0.1 was used with the Brois method, and measurement was performed as below. Absorbance was measured using an ELISA micro-reader. Total polyphenol content was also measured by the Folin-Ciocalteu method. The ELISA micro-reader (Infinite F50, Tecan Group Ltd., Switzerland) was used as the measuring device.

As shown in Table 3, as a result of using 5 parts by weight of the rhubarb powder, which is a food additive, in the broth seasoning liquid according to the present disclosure, the instant ginseng chicken soup of the present disclosure exhibited the highest values in both DPPH and total polyphenol content among the antioxidant effects.

### Example 3

After 5 parts by weight of the wormwood vinegar, which is a food additive, was added to the instant ginseng chicken soup according to the present disclosure, in order to compare the instant ginseng chicken soup according to the present disclosure with existing instant ginseng chicken soup products, the frozen pouches of instant ginseng chicken soup products were put into boiling water without change, heated for 40 to 50 minutes, and then a sensory test was performed thereon. The results of the sensory test are shown in Table 4. The results of evaluating off-flavor, texture, and taste of the instant ginseng chicken soup products by 6 well-trained laboratory researchers and 10 Harim housewife monitors using a 9-point scale (9 points: very good; 1 point: very bad) are shown in Table 4 below.

TABLE 4

| | | | Off- | |
|---|---|---|---|---|
| Object | Texture | Taste | flavor | Preference |
| Instant ginseng chicken soup of the | 7.8 | 7.9 | 7.7 | 1 |
| Present disclosure | | | | |
| Instant ginseng chicken soup | 7.2 | 7.4 | 7.5 | 2 |
| in market 1 | | | | |
| Instant ginseng chicken soup in | 7.1 | 7.3 | 7.5 | 3 |
| market 2 | | | | |

As shown in Table 4, in terms of texture, since chicken meat is cooked with 100% steam and the wormwood vinegar is contained in the instant ginseng chicken soup according to the present disclosure, moisture of inside and outside tissues of meat is maintained, and elasticity of meat is maintained. In contrast to the present disclosure, the instant ginseng chicken soup product in market 1 and the instant ginseng chicken soup product in market 2 have lost elasticity due to moisture being evaporated therefrom.

In terms of taste, due to an improved yield and being the most well-matched with the broth seasoning liquid, the instant ginseng chicken soup according to the present disclosure showed the highest score with respect to the instant ginseng chicken soup product in market 1 and the instant ginseng chicken soup product in market 2.

In terms of off-flavor, since off-flavor and disgusting odor unique to chicken were removed in the process of cooking chicken meat with 100% steam and adding the wormwood vinegar to the instant ginseng chicken soup according to the present disclosure, the instant ginseng chicken soup according to the present disclosure showed the highest score.

### Example 4

After 5 parts by weight of the wood vinegar, which is a food additive, was added to the instant ginseng chicken soup according to the present disclosure, in order to compare the instant ginseng chicken soup according to the present disclosure with existing instant ginseng chicken soup products, the frozen pouches of instant ginseng chicken soup products were put into boiling water without change, heated for 40 to 50 minutes, and then a sensory test was performed thereon. The results of the sensory test are shown in Table 5. The results of evaluating off-flavor, texture, and taste of the instant ginseng chicken soup products by 6 well-trained laboratory researchers and 10 Harim housewife monitors using a 9-point scale (9 points: very good; 1 point: very bad) are shown in Table 5 below.

TABLE 5

| | | | Off- | |
|---|---|---|---|---|
| Object | Texture | Taste | flavor | Preference |
| Instant ginseng chicken soup of the | 7.9 | 7.8 | 7.8 | 1 |
| Present disclosure | | | | |
| Instant ginseng chicken soup | 7.2 | 7.4 | 7.5 | 2 |
| in market 1 | | | | |
| Instant ginseng chicken soup in | 7.1 | 7.3 | 7.5 | 3 |
| market 2 | | | | |

As shown in Table 5, in terms of texture, since chicken meat is cooked with 100% steam and the wood vinegar is contained in the instant ginseng chicken soup according to the present disclosure, moisture of inside and outside tissues of meat is maintained, and elasticity of meat is maintained. In contrast to the present disclosure, the instant ginseng chicken soup product in market 1 and the instant ginseng chicken soup product in market 2 have lost elasticity due to moisture being evaporated therefrom.

In terms of taste, due to an improved yield and being the most well-matched with the broth seasoning liquid, the instant ginseng chicken soup according to the present disclosure showed the highest score with respect to the instant ginseng chicken soup product in market 1 and the instant ginseng chicken soup product in market 2.

In terms of off-flavor, since off-flavor and disgusting odor unique to chicken were removed in the process of cooking chicken meat with 100% steam and adding the wood vinegar to the instant ginseng chicken soup according to the present disclosure, the instant ginseng chicken soup according to the present disclosure showed the highest score.

### Example 5

Embodiment Related to Microorganism Growth Inhibiting Effect of (F)Rhodinic Acid Used as Food Additive

A chicken in instant ginseng chicken soup (product of Harim) was boiled, washed twice with cold water, and then dehydrated for 1 minute. 10 g of boiled instant ginseng chicken soup was dipped in 100 ml of solution for 30 seconds, dehydrated for 30 seconds on a strainer, held in a petri dish, and then stored at 25° C. For counting the total number of bacteria, the number of colonies resulting from culturing for 48 hours at 37° C. using a plate count agar was counted and indicated with colony forming unit (CFU)/ml. For counting the number of colon bacteria, the experiment was conducted in the same way for counting the total number of bacteria using a Chromocult (merck) medium. In this case, distilled water as a control group and (F)rhodinic acid were used.

TABLE 6

| | | Time | | |
|---|---|---|---|---|
| Sample | | 0 | 18 | 24 |
| Distilled water | Total number | 1.1 × 10³ | 2.7 × 10⁶ | 3.0 × 10⁸ |
| (control | of bacteria | | | |
| group) | Number of | ND | 7.1 × 10⁵ | 1.5 × 10⁶ |
| | colon bacteria | | | |
| F (rhodinic | Total number | 6.7 × 10² | 10 × 10⁵ | 8.9 × 10⁶ |
| acid) | of bacteria | | | |
| | Number of | ND | ND | ND |
| | colon bacteria | | | |

(The unit is CFU/ml, and “ND” is an abbreviation for “Not observed.”)

A result of the experiment shows that the total number of bacteria is different in the control group and (F)rhodinic acid at 0 hour. This indicates that, since the total number of bacteria is measured in a state in which (F)rhodinic acid and distilled water were mixed, a sterilization effect immediately occurred when mixing the (F)rhodinic acid and distilled water.

In more detail, the instant ginseng chicken soup product treated with (F)rhodinic acid exhibited a gradual increase in the total number of bacteria in comparison to the control group. That is, after 24 hours, since the control group exhibited up to 10⁸ CFU/ml and was close to being spoiled whereas bacteria did not proliferate more than 10⁶ CFU/ml in the group treated with (F)rhodinic acid, it can be seen that treating instant ginseng chicken soup with (F)rhodinic acid has an effect of inhibiting the growth of microorganisms therein. In terms of colon bacteria, the number of colon bacteria increased with time in the control group and up to 10⁶ CFU/ml was detected after 24 hours, whereas no colon bacteria were detected in the group treated with (F)rhodinic acid even up to 24 hours. This indicates that (F)rhodinic acid has the sterilization effect.

### Example 6

To further improve the preference for the instant ginseng chicken soup according to the present disclosure, the rhubarb powder, the wormwood vinegar, the wood vinegar, and (F)rhodinic acid were prepared, a food additive in which the prepared rhubarb powder, wormwood vinegar, wood vinegar, and (F)rhodinic acid were mixed in a ratio of 5:2:2:1 was provided, 5 parts by weight of the food additive was diluted in 30 parts by weight of broth and 65 parts by weight of purified water, and an instant ginseng chicken soup product was produced using the same method as in Example 1.

In this case, the rhubarb powder, wormwood vinegar, wood vinegar, and (F)rhodinic acid were fixed in a ratio of 5:2:2:1. Then, sensory tests were conducted using the same methods as in Examples 3 and 4, and results thereof are shown in Table 7 below.

TABLE 7

| | Food additive (ratio) | | | | | | |
|---|---|---|---|---|---|---|---|
| | rhubarb | Wormwood | Wood | (F)Rhodinic | | Off- | |
| Object | powder | vinegar | vinegar | acid | Taste | flavor | Preference |
| Instant | 5 | 2 | 2 | 1 | 8.0 | 7.9 | 1 |
| ginseng | | | | | | | |
| chicken | | | | | | | |
| soup of | | | | | | | |
| the | | | | | | | |
| Present | | | | | | | |
| disclosure | | | | | | | |
| Instant | NO | NO | NO | NO | 7.4 | 7.5 | 2 |
| ginseng | | | | | | | |
| chicken | | | | | | | |
| soup | | | | | | | |
| in market 1 | | | | | | | |
| Instant | NO | NO | NO | NO | 7.3 | 7.5 | 3 |
| ginseng | | | | | | | |
| chicken | | | | | | | |
| soup in | | | | | | | |
| market 2 | | | | | | | |

(“NO” signifies that the corresponding food additive was not added)

As shown in Table 7 above, in a case in which the rhubarb powder, wormwood vinegar, wood vinegar, and (F)rhodinic acid were mixed in a ratio of 5:2:2:1 and used, the instant ginseng chicken soup according to the present disclosure exhibited the highest scores, including 8.0 as taste and 7.9 as absence of off-flavor and was also picked for the highest preference.

As described above, according to the present disclosure, since chicken meat with glutinous rice, fresh ginseng, and jujube put therein is cooked with 100% steam and heat-treated, an off-flavor and disgusting odor unique to chicken that may be produced in instant ginseng chicken soup can be eliminated, and since moisture is replenished inside and outside tissues of the chicken meat, elasticity of meat can be maintained.

In addition, since, when extracting broth using chicken feet, pressure and temperature can be adjusted using a heat exchange heater, homogenous broth can be extracted in short time.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of producing an instant ginseng chicken soup product, the method comprising:
cooking chicken meat, which is filled with stuffing, for ginseng chicken soup with 100% steam using a steam cooker;
extracting broth from chicken feet using a heat exchange heater;
diluting 65 parts by weight of purified water and 5 parts by weight of food additive in 30 parts by weight of the extracted broth and then adding a seasoning agent thereto to obtain a broth seasoning liquid; and
packing the prepared chicken meat and the broth seasoning liquid in a package and performing a retort heat treatment and rapid freezing at a temperature less than or equal to −35° C.

2. The method of claim 1, wherein the food additive is rhubarb powder in a powder form obtained by pulverizing rhubarb leaf stalks.

3. The method of claim 1, wherein the food additive is a wormwood vinegar.

4. The method of claim 1, wherein the food additive is a wood vinegar.

5. The method of claim 1, wherein the food additive is an (F)rhodinic acid.

6. The method of claim 1, wherein the food additive includes rhubarb powder in a powder form obtained by pulverizing rhubarb leaf stalks, a wormwood vinegar, a wood vinegar, and an (F)rhodinic acid.

7. The method of claim 6, wherein the rhubarb powder, the wormwood vinegar, the wood vinegar, and the (F)rhodinic acid were prepared, a food additive in which the prepared rhubarb powder, wormwood vinegar, wood vinegar, and (F)rhodinic acid were mixed in a ratio of 5:2:2:1 was provided, and then 5 parts by weight of the food additive was diluted in 30 parts by weight of broth and 65 parts by weight of purified water.
